(19) United States
(12) Patent Application Publication
(10) Pub. No.: US 2016/0092492 A1
(43) Pub. Date: Mar. 31, 2016

(54) SHARING INITIAL DICTIONARIES AND HUFFMAN TREES BETWEEN MULTIPLE COMPRESSED BLOCKS IN LZ-BASED COMPRESSION ALGORITHMS

(71) Applicant: QUALCOMM Incorporated, San Diego, CA (US)

(72) Inventors: Michael ZIMMER, Berkeley, CA (US); Richard SENIOR, San Diego, CA (US); Swaminathan SURESHCHANDRAN, San Diego, CA (US); Venkata Ramanan VENKATACHALAM JAYARAMAN, Del Mar, CA (US)

(21) Appl. No.: 14/499,148

(22) Filed: Sep. 27, 2014

(51) Int. Cl. G06F 17/30

(52) U.S. Cl. CPC G06F 17/30371; G06F 17/30327

(57) ABSTRACT

A string of data is partitioned into a set of blocks. Each block is compressed based on a set of initial dictionaries and a set of Huffman trees. Each block is associated by a pointer with an initial dictionary in the set of initial dictionaries and a Huffman tree in the set of Huffman trees used to compress that block. A compressed string of data includes the set of initial dictionaries, the set of Huffman trees, and the compressed blocks and associated pointers.

### FIELD OF DISCLOSURE

Embodiments pertain to lossless data compression, and in particular, data compression utilizing Lempel-Ziv type lossless compression with Huffman trees.

### BACKGROUND

Conventional use of LZ (Lempel-Ziv) type lossless compression schemes makes use of relatively large block sizes. For example, a large block (string) of data may be compressed with an LZ-type algorithm starting with an initial dictionary, followed by encoding with a Huffman tree. The initial dictionary and Huffman tree are made known to a decoder. For random access retrieval, it may be desirable to partition data into relatively small blocks before compression, so that each compressed block of data may be accessed and decompressed independently. Current schemes for using LZ compression methods and Huffman trees on small blocks can lead to undesirable overhead because of the memory requirements for storing what can be many initial dictionaries and Huffman trees needed for decoding.

### SUMMARY

Embodiments of the invention are directed to systems and methods that can provide, among other features and benefits, reduction of memory resources and other overhead, by sharing initial dictionaries and Huffman trees among multiple compressed blocks in Lempel-Ziv compression schemes.

Example methods according to one or more exemplary embodiments may include partitioning a string of data into a set of blocks, compressing each block in the set of blocks to generate a set of compressed blocks, wherein the compressing may be based on a set of initial dictionaries and a set of Huffman trees. In an aspect, each compressed block may be associated, by a pointer, with an initial dictionary in the set of initial dictionaries and a Huffman tree in the set of Huffman trees, used to compress the block. In an aspect, example methods according to one or more exemplary embodiments can further include generating a compressed string of data, the compressed string of data including the set of initial dictionaries, the set of Huffman trees, and the compressed blocks and associated pointers.

In an aspect, the compressing based on the set of initial dictionaries may be based on a Lempel-Ziv compression.

In an aspect, the compressing may include selecting, for each block, an initial dictionary among the set of initial dictionaries and a Huffman tree among the set of Huffman trees and, in a related aspect, generating a string of compressed data may include appending to each compressed block a header with a reference to the initial dictionary and a reference to the Huffman tree used for compressing that block.

In an aspect, compressing of at least one of the blocks may include compressing the block by a Lempel-Ziv compression based on the initial dictionary, to generate a Lempel-Ziv compressed block, performing a dry run compression on the Lempel-Ziv compressed block to generate symbols, determining a frequency count of each of the generated symbols, and selecting the Huffman tree for compressing the Lempel-Ziv compressed block based on the determined frequency counts.

Examples of computer program products according to one or more exemplary embodiments may include a computer readable medium storing instructions that when executed by a computer can cause the computer to receive a string of data, partition the string of data into a set of blocks, and compress each block in the set of blocks to generate a set of compressed blocks. In an aspect, the compressing may be based on a set of initial dictionaries and a set of Huffman trees. In a further aspect, the computer readable medium stored instructions may include instructions that, when executed by the computer, cause the computer associate each block by a pointer with an initial dictionary in the set of initial dictionaries and a Huffman tree in the set of Huffman trees used to compress each block. In an aspect, the computer readable medium stored instructions can, when executed by the computer, cause the computer to generate a compressed string of data, the compressed string of data including the set of initial dictionaries, the set of Huffman trees, and the compressed blocks and associated pointers.

Example of an apparatus according to one or more exemplary embodiments may include a processor and a memory, coupled to the processor, and the memory may store instructions readable and executable by the processor. In an aspect, the instructions can include instructions that, when executed by the processor, can cause the processor to receive a string of data, partition the string of data into a set of blocks, and compress each block in the set of blocks to generate a set of compressed blocks. In an aspect, the instructions that, when executed by the processor, cause the process to compress blocks, can include instructions that base the compressing on a set of initial dictionaries and a set of Huffman trees, and instructions that may associate each block, by a pointer with an initial dictionary in the set of initial dictionaries and a Huffman tree in the set of Huffman trees used to compress the blocks. In an aspect, the instructions can include instructions that, when executed by the processor, can cause the processor to generate a compressed string of data, and the compressed string of data may include the set of initial dictionaries, the set of Huffman trees, and the compressed blocks and associated pointers.

Examples of an apparatus according to one or more exemplary embodiments may include means for partitioning a string of data into a set of blocks, and means for compressing each block in the set of blocks to generate a set of compressed blocks. In an aspect, the means for compressing may be configured to perform the compressing based on a set of initial dictionaries and a set of Huffman trees, and may be configured to generate, with each compressed block, a pointer to an initial dictionary in the set of initial dictionaries and a Huffman tree in the set of Huffman trees, used to compress each block. Examples of an apparatus according to one or more exemplary embodiments may include means for generating a compressed string of data, and the compressed string of data may include the set of initial dictionaries, the set of Huffman trees, and the compressed blocks and associated pointers.

### BRIEF DESCRIPTION OF THE DRAWINGS

The accompanying drawings are presented to aid in the description of embodiments of the invention and are provided solely for illustration of the embodiments and not limitation thereof.

FIG. 1 illustrates a method and data scheme according to an embodiment.

FIG. 2 is a flow diagram illustrating a method according to an embodiment.

FIG. 3 illustrates a communication network in which an embodiment may find application.

FIG. 4 illustrates a computer system for implementing a method according to an embodiment.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The term “embodiments of the invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that specific circuits (e.g., application specific integrated circuits (ASICs)), one or more processors executing program instructions, or a combination of both, may perform the various actions described herein. Additionally, the sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

To compress and decompress multiple blocks of data having similar data type, embodiments utilize a single initial dictionary and Huffman tree that are shared among the blocks. Given a large string of data partitioned into a set of blocks, a relatively small set of initial dictionaries and Huffman trees may be utilized, where a single initial dictionary and a single Huffman tree in the set of initial dictionaries and Huffman trees are shared among a subset of the set of blocks.

For an embodiment, plaintext data is partitioned into a set of blocks, with each block compressed using an initial dictionary and Huffman tree selected from a relatively small set of initial dictionaries and Huffman trees. Appended to each compressed block is a header with a reference to the particular initial dictionary and a reference to the particular Huffman tree needed for decoding. Initial dictionaries and Huffman trees may be paired so that a single reference may refer to a pair comprising an initial dictionary and paired Huffman tree. The sets of initial dictionaries and Huffman trees may be appended as compressed or uncompressed headers to the compressed blocks. The result is a string comprising compressed data and headers with all the information needed for decoding any particular compressed block independently of other compressed blocks.

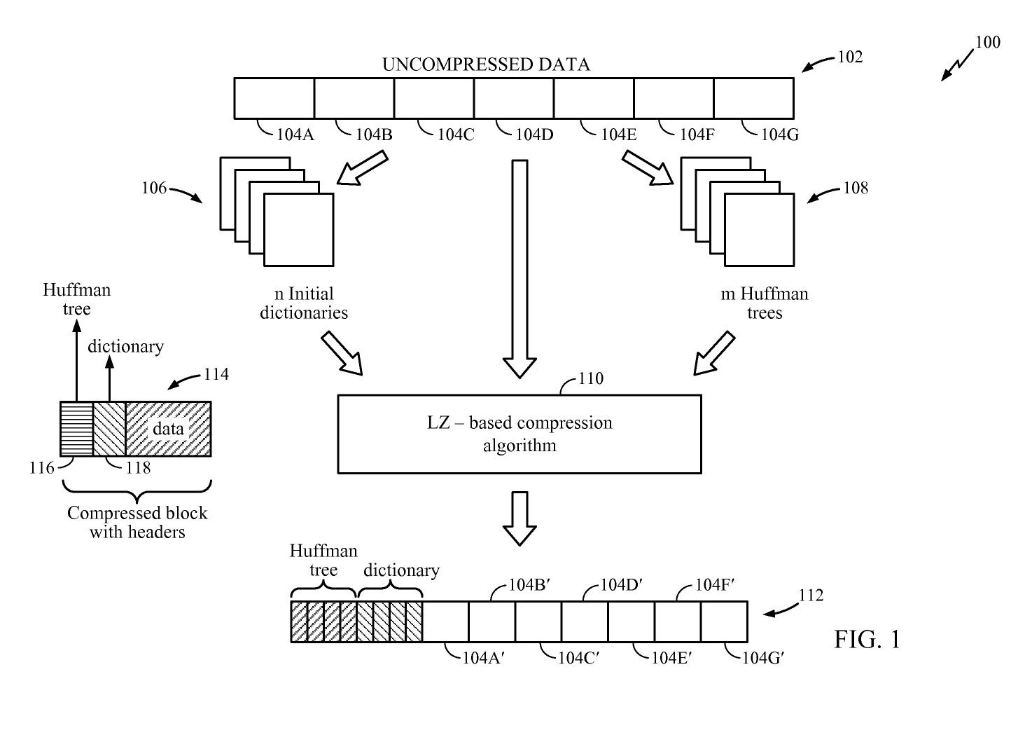

FIG. 1 illustrates a scheme 100 according to an embodiment for compressing a string of data 102. The data to be compressed is the string of data 102, which is divided into blocks labeled 104A, 104B, 104C, 104D, 104E, 104F, and 104G. In practice, the block size depends upon the application of the system, and represents a given granularity in accessing compressed data. For example, the string of data 102 may represent executable code, where each block is stored as a compressed block of executable code and when needed is retrieved from memory and then the retrieved compressed block can be decompressed, independently of other blocks. The result can be a generated block of executable code and upon, or during, the code being executed another block of compressed executable code may be retrieved and decompressed.

A set of n initial dictionaries for LZ-based compression is pictorially represented as four table data structures labeled 106, and a set of m Huffman trees is pictorially represented as four table data structures labeled 108. When a block is compressed, a suitable initial dictionary and Huffman tree are chosen to perform the compression. A LZ type compression is used, as indicated in the step 110. In addition to performing an LZ compression on a particular block, the resulting bits are further compressed using the particular Huffman tree chosen for that block. Lempel-Ziv and Huffman tree compression and decompression schemes are well known and need not be discussed in detail when describing embodiments.

The blocks resulting from compressing the blocks 104A, 104B, 104C, 104D, 104E, 104F, and 104G are respectively the blocks 104A′, 104B′, 104C′, 104D′, 104E′, 104F′, and 104G′. These blocks are part of the data string 112, which also includes the Huffman trees and the initial dictionaries.

Corresponding to each block 104A′, 104B′, 104C′, 104D′, 104E′, 104F′, and 104G′ are one or more pointers to indicate which initial dictionary and Huffman tree is to be used for decompression. Such pointers may occupy fields within the blocks 104A′, 104B′, 104C′, 104D′, 104E′, 104F′, and 104G′, such as a header, or they may occupy other fields of the data string 112. For example, the block 114 includes data that has been compressed according to an initial dictionary pointed to by the field 116 and a Huffman tree pointed to (identified) by the field 118. As a result, the data string 112 includes all the needed information to decompress the data stored in any particular block 104A′, 104B′, 104C′, 104D′, 104E′, 104F′, and 104G′.

Given data to be compressed, the set of initial dictionaries and Huffman trees may be developed heuristically. Heuristics may be used to find both the number of initial dictionaries and their contents. For a particular block compressed by an LZ-type algorithm using a particular initial dictionary, frequency counts of each resulting symbol may be obtained by performing dry-run compression. Heuristics may be used to find the set of Huffman trees used to compress the blocks.

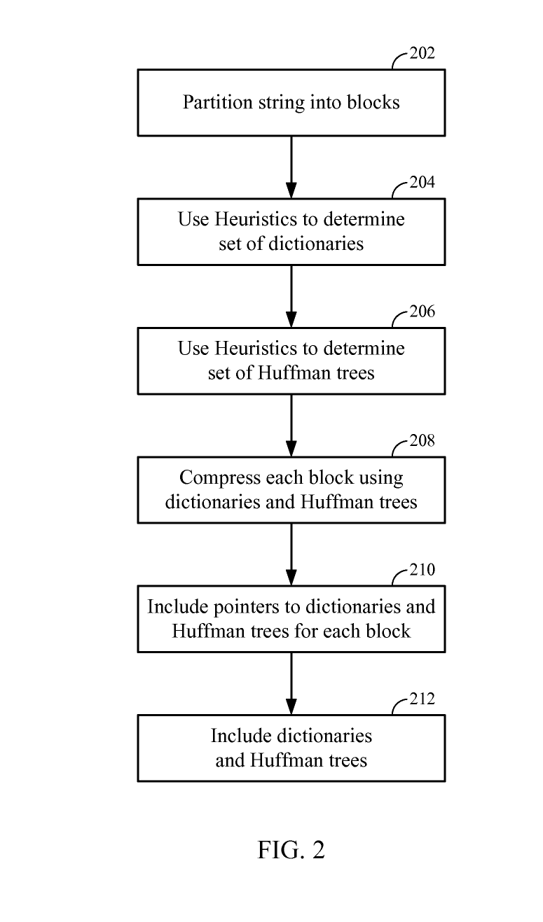

FIG. 2 illustrates a method according to the above-described embodiments. A string of data is partitioned into a set of blocks (202). Heuristics may be used to determine the set of initial dictionaries (204) as well as the set of Huffman trees (206). Each block is compressed using the dictionaries and Huffman trees (208). For example, the set of blocks may be partitioned into subsets, where each subset may be associated with a particular initial dictionary and Huffman tree. That is, associated with each subset of blocks is a pointer (or pointers) that point to (or indicate) a particular initial dictionary in the set of initial dictionaries and a particular Huffman tree in the set of Huffman trees (210). The set of dictionaries and the set of Huffman trees are included with the compressed subset of blocks (along with their pointers) to provide the compressed string of data from which the original blocks may be obtained after performing the inverse of the compression scheme (212).

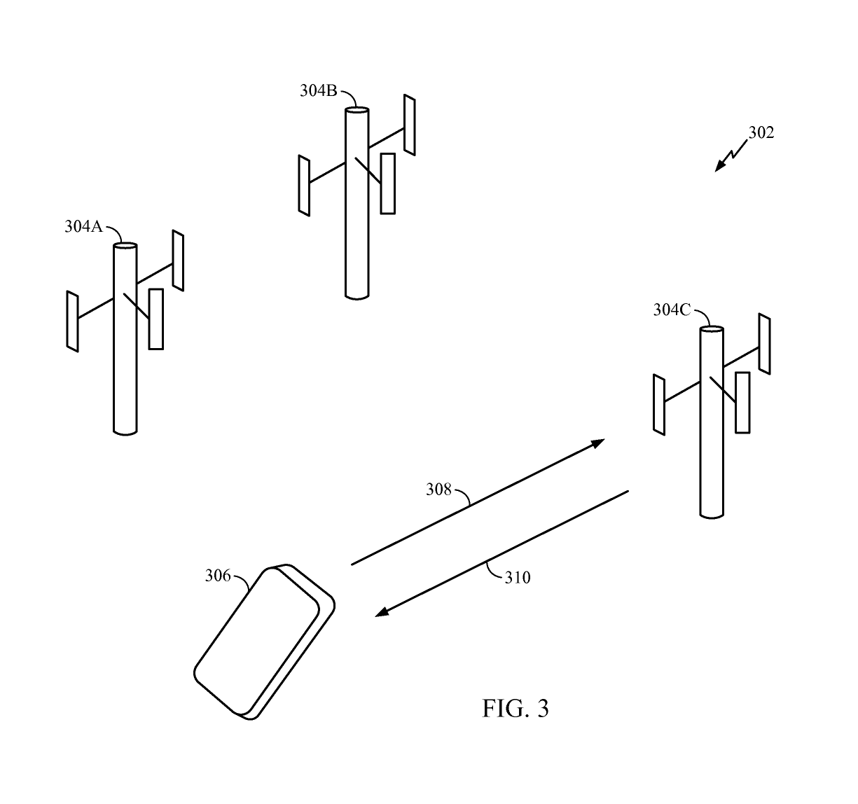

FIG. 3 illustrates a wireless communication system in which embodiments may find application. FIG. 3 illustrates a wireless communication network 302 comprising base stations 304A, 304B, and 304C. FIG. 3 shows a communication device, labeled 306, which may be a mobile communication device such as a cellular phone, a tablet, or some other kind of communication device suitable for a cellular phone network, such as a computer or computer system. The communication device 306 need not be mobile. In the particular example of FIG. 3, the communication device 306 is located within the cell associated with the base station 304C. Arrows 308 and 310 pictorially represent the uplink channel and the downlink channel, respectively, by which the communication device 306 communicates with the base station 304C.

Embodiments may be used in data processing systems associated with the communication device 306, or with the base station 304C, or both, for example. FIG. 3 illustrates only one application among many in which the embodiments described herein may be employed.

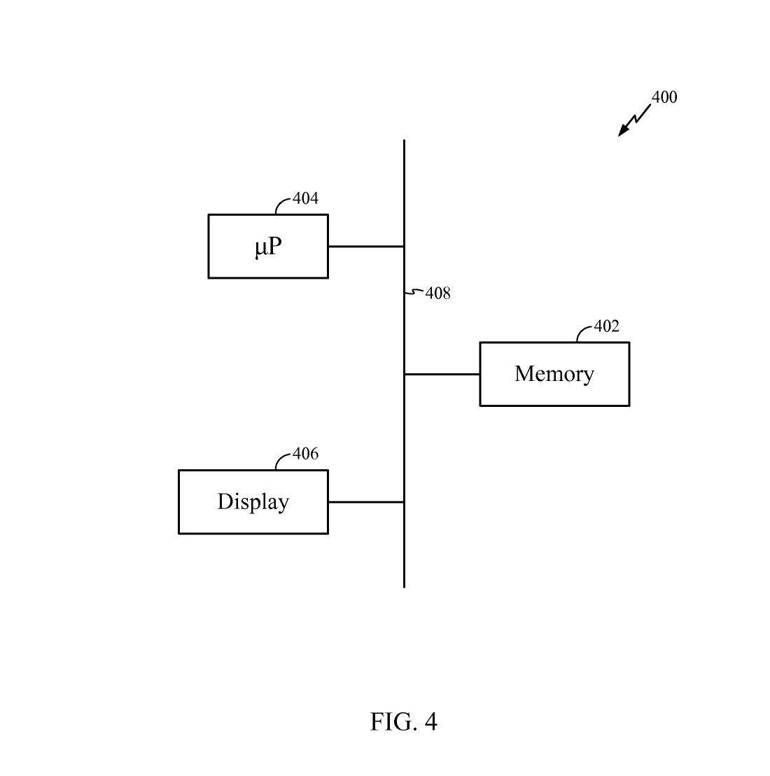

Embodiments may include non-transitory computer readable medium having stored instructions that when executed by a processor (or processors) cause a system to perform a method according to the previously described embodiments. For example, in the computer system of FIG. 4, executable instructions may be stored in the memory 402. The memory 402 may be part of a memory hierarchy. The instructions stored in the memory 402 may be executed by the processor 404, where the processor 404 and the memory 402 communicate by way of a communication path 408. For example, the communication path 408 may be realized as a bus. Additional components may be coupled to the processor 404 and the memory 402, where for ease of illustration only one other component, the display 406, is shown.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an embodiment of the invention can include a computer readable media embodying a method for sharing initial dictionaries and Huffman trees among multiple compressed blocks in Lempel-Ziv compression schemes. Accordingly, the invention is not limited to illustrated examples and any means for performing the functionality described herein are included in embodiments of the invention.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method, comprising:
partitioning a string of data into a set of blocks;
compressing each block in the set of blocks to generate a set of compressed blocks, wherein the compressing is based on a set of initial dictionaries and a set of Huffman trees, wherein each block is associated, by a pointer, with an initial dictionary in the set of initial dictionaries and a Huffman tree in the set of Huffman trees, used to compress said block; and
generating a compressed string of data, the compressed string of data including the set of initial dictionaries, the set of Huffman trees, and the compressed blocks and associated pointers.

2. The method of claim 1, wherein the compressing based on the set of initial dictionaries is based on a Lempel-Ziv compression.

3. The method of claim 1, wherein the compressing includes selecting, for each block, an initial dictionary among the set of initial dictionaries and a Huffman tree among the set of Huffman trees, and wherein generating a string of compressed data includes appending to each compressed block a header with a reference to the initial dictionary and a reference to the Huffman tree used for compressing that block.

4. The method of claim 3, wherein the compressing of at least one of the blocks includes:
compressing the block by a Lempel-Ziv compression based on the initial dictionary, to generate a Lempel-Ziv compressed block;
performing a dry run compression on the Lempel-Ziv compressed block to generate symbols;
determining a frequency count of each of the generated symbols; and
selecting the Huffman tree for compressing the Lempel-Ziv compressed block based on the determined frequency counts.

5. The method of claim 4, wherein the string of data is executable code for an application, executable by a processor, wherein the partitioning forms the blocks of the set of blocks with a block size based on a given granularity of the application, wherein the compressed blocks are compressed blocks of the executable code, and wherein the method further comprises:
storing the compressed blocks in a memory coupled to the processor;
retrieving one of the compressed blocks from the memory;
decompressing the retrieved compressed block, independently of other compressed blocks, using initial dictionary and the Huffman tree pointed to by the associated pointers of the retrieved compressed block, to generate a block of executable code; and
executing, by the processor, the generated block of executable code.

6. The method of claim 4, wherein the associated pointers include a pointer to the initial dictionary associated with the compressed block and a pointer to the Huffman tree associated with the compressed block.

7. The method of claim 6, wherein generating a compressed string of data is configured to append the set of initial dictionaries and the set of Huffman trees to the compressed string of data.

8. The method of claim 7, wherein generating a compressed string of data is further configured to append the set of initial dictionaries and the set of Huffman trees as a header of the compressed string of data.

9. The method of claim 3, wherein the string of data is executable code for an application, executable by a processor in a device, wherein the partitioning forms the blocks of the set of blocks with a block size based on a given granularity of the application, wherein the compressed blocks are compressed blocks of the executable code, and wherein the method further comprises:
storing the compressed blocks in a memory coupled to the processor;
retrieving one of the compressed blocks from the memory;
decompressing the retrieved compressed block, independently of other compressed blocks, using initial dictionary and the Huffman tree pointed to by the associated pointers of the retrieved compressed block, to generate a block of executable code; and
executing, by the processor, the generated block of executable code.

10. The method of claim 9, wherein generating a compressed string of data is configured to append the set of initial dictionaries and the set of Huffman trees to the compressed string of data.

11. The method of claim 9, wherein the device is selected from the group consisting of a cellular phone, a tablet, and a computer system.

12. A computer program product having a computer readable medium storing code that when executed by a computer cause the computer to receive a string of data;
partition the string of data into a set of blocks;
compress each block in the set of blocks to generate a set of compressed blocks, wherein the compressing is based on a set of initial dictionaries and a set of Huffman trees, wherein each block is associated by a pointer with an initial dictionary in the set of initial dictionaries and a Huffman tree in the set of Huffman trees used to compress said block; and
generate a compressed string of data, the compressed string of data including the set of initial dictionaries, the set of Huffman trees, and the compressed blocks and associated pointers.

13. The computer program product of claim 12, wherein the compressing based on the set of initial dictionaries is based on a Lempel-Ziv compression.

14. The computer program product of claim 12, wherein the code that, when executed, causes the computer to compress each block includes code that, when executed, causes the computer to select, for each block, an initial dictionary among the set of initial dictionaries and a Huffman tree among the set of Huffman trees, and
wherein the code that, when executed, causes the computer to generate a string of compressed data includes code that, when executed, causes the computer to append to each compressed block a header with a reference to the initial dictionary and a reference to the Huffman tree used for compressing that block.

15. The computer program product of claim 14, wherein the code that, when executed, causes the computer to compress each block includes code that, when executed, causes the computer to:
compress the block by a Lempel-Ziv compression based on the initial dictionary, to generate a Lempel-Ziv compressed block;
perform a dry run compression on the Lempel-Ziv compressed block to generate symbols;
determine a frequency count of each of the generated symbols;
select the Huffman tree for compressing the Lempel-Ziv compressed block based on the determined frequency counts; and
compress the Lempel-Ziv compressed block based on the Huffman tree to generate one of the compressed blocks.

16. The computer program product of claim 15, wherein the associated pointers include a pointer to the initial dictionary associated with the compressed block and a pointer to the Huffman tree associated with the compressed block.

17. The computer program product of claim 16, wherein the code that, when executed, causes the computer to generate a compressed string of data includes code that, when executed, causes the computer to append the set of initial dictionaries and the set of Huffman trees to the compressed string of data.

18. The computer program product of claim 14, wherein the string of data is executable code for an application, executable by a processor, wherein the code that, when executed, causes the computer to partition the string of data includes code that, when executed, causes the computer to form the blocks of the set of blocks with a block size based on a given granularity of the application, wherein the compressed blocks are compressed blocks of the executable code, and wherein the computer readable medium further stores instructions that, when executed by the computer, cause the computer to:
store the compressed blocks in a memory coupled to the processor;
retrieve one of the compressed blocks from the memory; and
decompress the retrieved compressed block, independently of other compressed blocks, using initial dictionary and the Huffman tree pointed to by the associated pointers of the retrieved compressed block, to generate a block of executable code.

19. The computer program product of claim 18, wherein the code that, when executed, causes the computer to generate a compressed string of data includes code that, when executed, causes the computer to append the set of initial dictionaries and the set of Huffman trees to the compressed string of data.

20. An apparatus comprising:
a processor;
a memory, coupled to the processor, wherein the memory stores instructions readable and executable by the processor, wherein the instructions include instruction that, when executed by the processor, cause the processor to
receive a string of data;
partition the string of data into a set of blocks;
compress each block in the set of blocks to generate a set of compressed blocks, wherein the compressing is based on a set of initial dictionaries and a set of Huffman trees, wherein each block is associated by a pointer with an initial dictionary in the set of initial dictionaries and a Huffman tree in the set of Huffman trees used to compress said block; and
generate a compressed string of data, the compressed string of data including the set of initial dictionaries, the set of Huffman trees, and the compressed blocks and associated pointers.

21. The apparatus of claim 20, wherein the compressing based on the set of initial dictionaries is based on a Lempel-Ziv compression.

22. The apparatus of claim 21, wherein the instructions that, when executed, cause the processor to compress each block include instructions that, when executed, cause the processor to select, for each block, an initial dictionary among the set of initial dictionaries and a Huffman tree among the set of Huffman trees, and
wherein the instructions that, when executed, cause the processor to generate a string of compressed data include instructions that, when executed, cause the processor to append to each compressed block a header with a reference to the initial dictionary and a reference to the Huffman tree used for compressing that block.

23. The apparatus of claim 22, wherein the associated pointers include a pointer to the initial dictionary associated with the compressed block and a pointer to the Huffman tree associated with the compressed block.

24. The apparatus of claim 22, wherein the instructions that, when executed, cause the processor to compress each block include instructions that, when executed, causes the processor to:
compress the block by a Lempel-Ziv compression using the initial dictionary, to generate a Lempel-Ziv compressed block;
perform a dry run compression on the Lempel-Ziv compressed block to generate symbols;
determine a frequency count of each of the generated symbols;
select the Huffman tree for compressing the Lempel-Ziv compressed block based on the determined frequency counts; and
compress the Lempel-Ziv compressed block based on the Huffman tree to generate one of the compressed blocks.

25. The apparatus of claim 24, wherein the associated pointers include a pointer to the initial dictionary associated with the compressed block and a pointer to the Huffman tree associated with the compressed block.

26. An apparatus, comprising:
means for partitioning a string of data into a set of blocks;
means for compressing each block in the set of blocks to generate a set of compressed blocks, wherein the means for compressing is configured to perform the compressing based on a set of initial dictionaries and a set of Huffman trees, and is configured to generate, with each compressed block, a pointer to an initial dictionary in the set of initial dictionaries and a Huffman tree in the set of Huffman trees, used to compress said each block; and
means for generating a compressed string of data, the compressed string of data including the set of initial dictionaries, the set of Huffman trees, and the compressed blocks and associated pointers.

27. The apparatus of claim 26, wherein the means for compressing is configured to perform the compressing based on the set of initial dictionaries as based on a Lempel-Ziv compression.

28. The apparatus of claim 27, wherein the means for compressing is configured to select, for each block, an initial dictionary among the set of initial dictionaries and a Huffman tree among the set of Huffman trees, and wherein the means for generating a string of compressed data is configured to append to each compressed block a header with the associated pointers, wherein the associated pointers are configured to reference the initial dictionary and to reference the Huffman tree used for compressing that block.

29. The apparatus of claim 28 wherein the means for generating a compressed string of data is configured to append the set of initial dictionaries and the set of Huffman trees to the compressed string of data.

30. The apparatus of claim 28, wherein the means for compressing is configured to include, in compressing at least one of the blocks:
compressing the block by a Lempel-Ziv compression based on the initial dictionary, to generate a Lempel-Ziv compressed block;
performing a dry run compression on the Lempel-Ziv compressed block to generate symbols;
determining a frequency count of each of the generated symbols; and
selecting the Huffman tree for compressing the Lempel-Ziv compressed block based on the determined frequency counts.
